(19) United States
(12) Patent Application Publication
(10) Pub. No.: US 2016/0229124 A1
(43) Pub. Date: Aug. 11, 2016

(54) Three-Dimensional Object Formation Apparatus, Three-Dimensional Object Formation Method, and Three-Dimensional Object Formation Program

(71) Applicant: Seiko Epson Corporation, Tokyo (JP)

(72) Inventor: Eishin Yoshikawa, Shiojiri-shi (JP)

(21) Appl. No.: 15/009,997

(22) Filed: Jan. 29, 2016

(30) Foreign Application Priority Data
Feb. 9, 2015 (JP) 2015-022923

(51) Int. Cl. B29C 67/00

(52) U.S. Cl. CPC B29C 67/0088; B29C 67/0055; B29C 67/0085; B29K 2105/0058

(57) ABSTRACT

Provided is a three-dimensional object formation apparatus including: a discharging unit which discharges a plurality achromatic colored liquids and a colorless transparent liquid; and a curing unit which cures a liquid discharged from the discharging unit to a formation table to form a plurality of voxels configuring a three-dimensional object on the formation table, in which a display color and transparency of the voxel are set, the discharging unit discharges the colored liquid by an amount of liquid according to the display color, and discharges the achromatic colored liquids and the colorless transparent liquid by an amount of the liquids at a ratio according to the transparency, so that a remaining portion which is other than a portion filled with the discharged colored liquid among total capacity of the voxel is filled, and the curing unit cures the discharged colored liquid and the transparent liquid to form the voxels.

This application claims priority to Japanese Patent Application No. 2015-022923 filed on Feb. 9, 2015. The entire disclosure of Japanese Patent Application No. 2015-022923 is hereby incorporated herein by reference.

### BACKGROUND

1. Technical Field

The present invention relates to a three-dimensional object formation apparatus which forms a three-dimensional object, a three-dimensional object formation method performed by the three-dimensional object formation apparatus, and a three-dimensional object formation program.

2. Related Art

In the related art, various three-dimensional object formation apparatuses such as a 3D printer for forming a three-dimensional object have been proposed. The three-dimensional object formation apparatus discharges, for example, photocurable liquid (ink) from a plurality of nozzles provided in a discharging unit to a formation table, cures the liquid by irradiating the with light, and forms a three-dimensional object having a predetermined shape on the formation table.

In such a three-dimensional object formation apparatus, a three-dimensional object which is a target is formed by forming a plurality of cubic voxels, each of which is a volume unit configuring an object. That is, a plurality of cubic voxels configuring a three-dimensional object have a unit height in a normal direction of a plane with respect to voxels configuring a two-dimensional planar image. Therefore, in a case of forming a three-dimensional object, it is necessary that inner portions of voxels are filled with liquid, in order to form cubic voxels having a unit height, and an amount of liquid for filling capacity of a voxel is discharged from nozzles to one voxel.

At that time, in a three-dimensional object formation apparatus of the related art, a plurality of colored liquids which can be mixed to generate a color of a three-dimensional object which is a formation target are discharged from nozzles by an amount of the liquids for filling inner portions of voxels, and voxels having a predetermined color (display color) are formed. For example, in such an apparatus, chromatic resins (liquids) which are respectively colored to yellow, magenta, and cyan and an achromatic resin (liquid) which is colored to white or black are discharged from discharging nozzles (nozzles) to form voxels having a predetermined color (display color) (see JP-A-2000-280357).

However, voxels which are formed using chromatic or achromatic colored liquids (resins) as in the apparatus of the related art may become opaque. Accordingly, when a three-dimensional object which is a formation target have transparent or semi-transparent portions, in addition to the opaque portions, it is difficult to form voxels configuring transparent or semi-transparent portions of a three-dimensional object by the three-dimensional object formation apparatus of the related art.

Such a problem commonly occurs in a three-dimensional object formation apparatus including a discharging unit which includes nozzles for discharging liquid and a curing unit which cures liquid discharged to a formation table to form a three-dimensional object on the formation table.

### SUMMARY

An advantage of some aspects of the invention is to provide a three-dimensional object formation apparatus, a three-dimensional object formation method, and a three-dimensional object formation program which can control transparency of a three-dimensional object to be formed.

Hereinafter, means of the invention and operation effects thereof will be described.

According to an aspect of the invention, there is provided a three-dimensional object formation apparatus including: a discharging unit which discharges a plurality of achromatic colored liquids and a colorless transparent liquid; and a curing unit which cures a liquid discharged from the discharging unit to a formation table to form a voxel configuring a three-dimensional object on the formation table, in which a display color and transparency of the voxel are set, the discharging unit discharges the colored liquid by an amount of liquid according to the display color, and discharges the achromatic colored liquids and the colorless transparent liquid by an amount of the liquids at a ratio according to the set transparency, so that a remaining portion which is other than a portion filled with the discharged colored liquid among total capacity of the voxel is filled, and the curing unit cures the discharged colored liquid and the transparent liquid to form the voxels.

In this case, the voxel configuring the three-dimensional object have the display color set by the discharged colored liquid and the set transparency by a ratio between the amount of discharged achromatic liquid and the amount of the discharged colorless transparent liquid. Accordingly, regarding the three-dimensional object to be formed with voxels, it is possible to prevent a change of the display color (hue) of the voxel and to control the transparency, by the achromatic liquid and the colorless transparent liquid.

In the three-dimensional object formation apparatus, it is preferable that the discharging unit discharges the white liquid among the achromatic colored liquids and the colorless transparent liquid by an amount of the liquids at a ratio according to the set transparency.

In this case, the transparency of the voxel to be formed is controlled by a liquid amount ratio between the white liquid and the colorless transparent liquid to be discharged. Accordingly, regarding the three-dimensional object to be formed with a plurality of voxels, it is possible to control the set transparency while preventing a change of the hue, without darkening the display color.

In the three-dimensional object formation apparatus, it is preferable that the discharging unit discharges the colored liquids so that the remaining portion is formed in the voxel.

In this case, a state where the all portions of the voxels are filled with the colored liquids discharged for generating the display color of the three-dimensional object is prevented, and a remaining portion to which the achromatic liquid and the colorless transparent liquid can be discharged is formed in the voxel. Accordingly, regarding the three-dimensional object to be formed with a plurality of voxels, it is possible to control the transparency by the achromatic liquid and colorless transparent liquid.

According to another aspect of the invention, there is provided a three-dimensional object formation method which is executed by a three-dimensional object formation apparatus including a discharging unit which discharges a plurality of achromatic colored liquids and a colorless transparent liquid, and a curing unit which cures a liquid discharged from the discharging unit to a formation table to form a voxel configuring a three-dimensional object on the formation table in which a display color and transparency of the voxel are set, the method including: causing the discharging unit to discharge the colored liquid by an amount of liquid according to the display color, and discharge the achromatic colored liquids and the colorless transparent liquid by an amount of the liquids at a ratio according to the set transparency, so that a remaining portion which is other than a portion filled with the discharged colored liquid among total capacity of the voxel is filled; and causing the curing unit to cure the discharged colored liquid and the transparent liquid to form the voxels.

In this case, the voxel configuring the three-dimensional object have the display color set by the discharged colored liquid and the set transparency by a ratio between the amount of discharged achromatic liquid and the amount of the discharged colorless transparent liquid. Accordingly, regarding the three-dimensional object to be formed with voxels, it is possible to prevent a change of the display color (hue) of the voxel and to control the transparency, by the achromatic liquid and the colorless transparent liquid.

According to still another aspect of the invention, there is provided a three-dimensional object formation program executed by a control unit of a three-dimensional object formation apparatus including a discharging unit which discharges a plurality of achromatic colored liquids and a colorless transparent liquid, a curing unit which cures a liquid discharged from the discharging unit to a formation table to form a voxel configuring a three-dimensional object on the formation table, and the control unit which controls the discharging unit and the curing unit, in which a display color and transparency of the voxel are set, and the three-dimensional object formation program causes the control unit to execute: causing the discharging unit to discharge the colored liquid by an amount of liquid according to the display color, and discharge the achromatic colored liquids and the colorless transparent liquid by an amount of the liquids at a ratio according to the set transparency, so that a remaining portion which is other than a portion filled with the discharged colored liquid among total capacity of the voxel is filled; and causing the curing unit to cure the discharged colored liquid and the transparent liquid to form the voxels.

In this case, the voxel configuring the three-dimensional object have the display color set by the discharged colored liquid and the set transparency by a ratio between the amount of discharged achromatic liquid and the amount of the discharged colorless transparent liquid. Accordingly, regarding the three-dimensional object to be formed with voxels, it is possible to prevent a change of the display color (hue) of the voxel and to control the transparency, by the achromatic liquid and the colorless transparent liquid.

### BRIEF DESCRIPTION OF THE DRAWINGS

The invention will be described with reference to the accompanying drawings, wherein like numbers reference like elements.

FIG. 1 is a schematic view showing a schematic configuration of one embodiment of a three-dimensional object formation apparatus.

FIG. 2A is a schematic view showing a configuration of formation of a three-dimensional object (voxels) performed in the three-dimensional object formation apparatus and FIG. 2B is a perspective view showing a three-dimensional object (voxels) to be formed.

FIG. 3 is a schematic view showing nozzles of a discharging unit which discharges liquid when forming voxels.

FIG. 4 is a flowchart showing a three-dimensional object formation operation process which is performed in the three-dimensional object formation apparatus.

FIG. 5 is a table showing an example of colored liquid discharge data showing discharged amounts of each colored liquid which are converted from color data of voxels, and remaining capacity of voxels.

FIG. 6 is a table showing examples of a liquid amount ratio between colored liquid and transparent liquid according to transparency of voxels.

FIGS. 7A and 7B are schematic views showing voxels formed in a formation operation of a three-dimensional object.

FIG. 8 is a schematic view showing an example of voxels formed according to transparency.

### DESCRIPTION OF EXEMPLARY EMBODIMENTS

Hereinafter, a printer including a discharging unit which includes a plurality of nozzles which can discharge liquid and a curing unit which cures liquid discharged from the discharging unit to a formation table will be described as one embodiment of a three-dimensional formation apparatus with reference to the drawings.

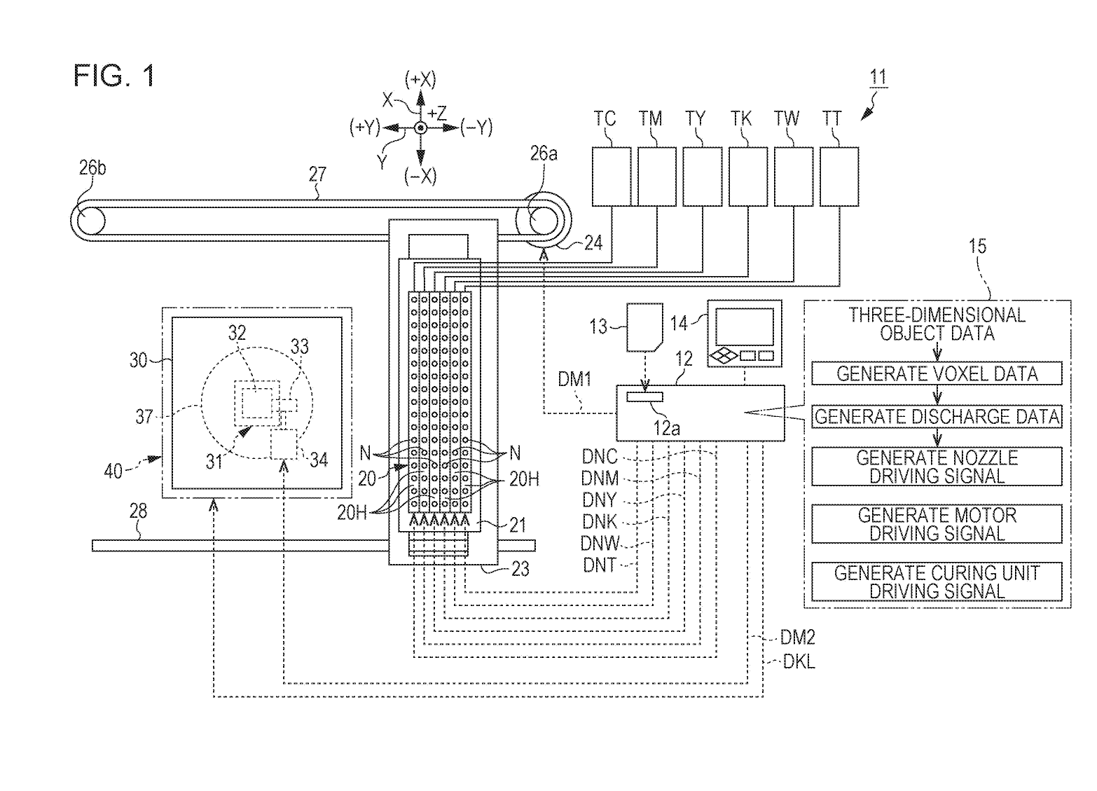

As shown in FIG. 1, a printer 11 which is an example of a three-dimensional formation apparatus includes a discharging unit 20 which includes a plurality of nozzles N which can discharge liquid so as to be arranged in one direction and setting an arrangement direction of the plurality of nozzles N as a longitudinal direction, and a formation table 30 which is a table receiving liquid discharged from the discharging unit 20.

The discharging unit 20 is configured with six individual heads 20H which are arranged in parallel in a short direction intersecting with the longitudinal direction. Each of the six individual heads 20H is set as one line head having at least a length of a three-dimensional object to be formed on the formation table 30. Five types of colored liquids including cyan, magenta, and yellow chromatic liquid Cy, Ma, and Ye and black and white achromatic liquid Ku and Wh and a colorless transparent liquid Tm are respectively discharged from nozzles N of the six individual heads 20H.

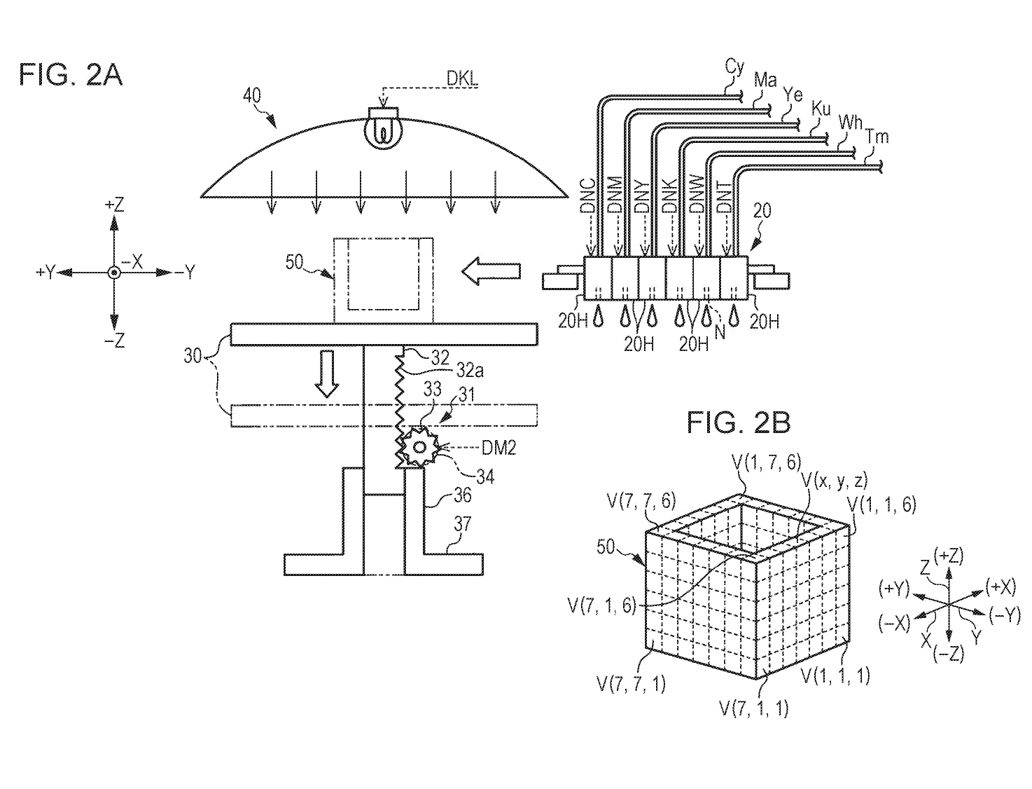

In the embodiment, six liquid containers TC, TM, TY, TK, TW, and TT which contain the chromatic liquid Cy, Ma, Ye, Ku, and Wh and the colorless transparent liquid Tm are connected to the six individual heads 20H through flexible tubes which can supply liquid. When forming a three-dimensional object, the chromatic liquid Cy, Ma, Ye, Ku, and Wh and the colorless transparent liquid Tm supplied through the flexible tubes are discharged from each of the individual heads 20H (discharging unit 20) to the formation table 30 (see FIG. 2A).

The discharging unit 20 configured with the six individual heads 20H is fixed to a head fixing plate 21 and the head fixing plate 21 is attached to a carriage 23 which moves according to rotation driving of a first motor 24 which is a driving source.

The carriage 23 has a longitudinal direction in the same direction as that of the discharging unit 20. One end side thereof in the longitudinal direction is fixed to a part of an endless belt 27 which is stretched between a driving roller 26a and a driven roller 26b. At least a part of the carriage 23 (herein, the other end side thereof in the longitudinal direction) is guided by a linearly extending guiding member 28 and attached so as to be movable in a short direction which is the arrangement direction of the individual heads 20H which intersects (is orthogonal, herein) the longitudinal direction. Accordingly, the carriage 23 moves in the short direction with the belt 27 which moves according to the rotation of the driving roller 26a which is rotatably driven by the first motor 24 which is a driving source. The discharging unit 20 can reciprocate over the entire region of the formation table 30 according to the movement of the carriage 23 in the short direction.

In the embodiment, regarding the movement directions of the discharging unit 20, the short direction is referred to as a main scanning direction Y and the longitudinal direction thereof is referred to as an auxiliary scanning direction X. In addition, a side of the discharging unit in the main scanning direction Y which is a direction where the discharging unit 20 moves when starting the formation of a three-dimensional object and which is close to the formation table is set as +Y side and a side of the discharging unit 20 fixed to the belt 27 in the auxiliary scanning direction X is set as +X side.

Regarding the formation table 30, an upper direction on a +Z side in a antigravity direction is a rectangular flat surface and a normal direction thereof is set as a vertical direction Z. The formation table 30 can be lifted up and down by a lifting unit 31 which is positioned on a −Z side in a gravity direction, so that a distance between the discharging unit 20 which moves in the main scanning direction Y and the formation table in the vertical direction Z changes (see FIG. 2A). In the embodiment, the lifting unit 31 includes a rack 32a which is provided on one surface of a prop 32 which supports the formation table 30 and has a rectangular cross section, and a second motor 34 in which a pinion 33 which is engaged with teeth of the rack 32a is fixed to a rotation shaft, and the height of the formation table 30 in the vertical direction Z changes according to driving of the second motor 34.

A curing unit 40 which is arranged so as to be overlapped with the formation table 30 in the vertical direction Z and irradiates substantially the entire area of the upper surface of the rectangular formation table 30 with light (for example, ultraviolet light) having a predetermined wavelength for curing liquid discharged onto the formation table 30.

The printer 11 includes a control unit 15 which controls a movement operation of the carriage 23 in the main scanning direction Y or a discharging operation of liquid from the discharging unit 20 (nozzles N) to the −Z side in the gravity direction. The control unit 15 further controls a lifting operation of the formation table 30 performed by the lifting unit 31 or a light irradiation operation of the curing unit 40.

In the embodiment, the printer 11 includes a housing 12 in which an electric circuit (not shown) including a CPU, RAM, or ROM configuring a computer is embedded. A recording medium 13 is inserted into an insertion port 12a provided in the housing 12 and a computer is operated according to a program recorded (stored) in the inserted recording medium 13 by signals input using a display unit or operation buttons provided in an operation unit 14 which is connected to the electric circuit in the housing 12. With this operation, a computer functions as the control unit 15 and controls a formation operation of a three-dimensional object of the printer 11.

That is, the control unit 15 functioned by a computer generates voxel data from formation data (for example, three-dimensional CAD data) of a three-dimensional object which is a formation target, for a plurality of voxels configuring the three-dimensional object. In the embodiment, each voxel has set display color (herein, a hue and a chroma) and transparency. Accordingly, the control unit 15 generates position data showing a position of a voxel in a three-dimensional space, color data (for example, R, G, and B data) showing a display color of a voxel, and transparency data showing transparency of a voxel, as voxel data items regarding each voxel.

The control unit 15 performs a necessary process such as a color conversion process or a half-tone process based on the generated voxel data items, and generates discharging data, regarding each nozzle N included in the discharging unit 20, showing amounts of each liquid of colored liquids Cy, Ma, Ye, Ku, and Wh and the transparent liquid Tm to be discharged so as to fill the inner portion of each voxel. The control unit generates nozzle driving signals DNC, DNM, DNY, DNK, DNW, and DNT for discharging liquid of each nozzle in the individual heads 20H which discharge each of the colored liquids Cy, Ma, Ye, Ku, and Wh and the transparent liquid Tm, from the generated discharging data.

The control unit 15 generates a first motor driving signal DM1 for reciprocating the carriage 23 and a second motor driving signal DM2 for lifting up and down the formation table 30, in order to form a three-dimensional object on the formation table 30. The control unit 15 further generates a curing unit driving signal DKL for emitting light from the curing unit 40.

The generated data items and driving signals are recorded in a recording unit (not shown) such as a memory configuring a computer and are read out or output by the control unit 15 at a predetermined timing when forming a three-dimensional object.

In the embodiment, as shown in FIGS. 2A and 2B, a rectangular box 50 having four standing walls as side walls and a bottom is formed on the formation table 30 as a three-dimensional object and voxel data of the rectangular box 50 is generated by the control unit 15. That is, as shown in FIG. 2B, the rectangular box 50 is configured with seven voxels respectively in the main scanning direction Y and the auxiliary scanning direction X and is configured with six voxels in the vertical direction Z. A position of each voxel which is a volume unit for configuring the rectangular box 50 is specified with a coordinate (x,y,z) including the auxiliary scanning direction X, the main scanning direction Y, and the vertical direction Z as a three-dimensional coordinate system, and herein, a specified voxel is indicated as a voxel V (x,y,z).

In the embodiment, the rectangular box 50 is configured with six voxel layers which are laminated on each other in the vertical direction Z, the lowermost layer on the −Z side thereof in the gravity direction is set as a first layer and the uppermost layer on the +Z side thereof in the antigravity direction is set as a sixth layer. In each voxel layer, a voxel from the +X side in the auxiliary scanning direction X is counted as a first voxel and a voxel from the −Y side in the main scanning direction Y is counted as a first voxel. Accordingly, as shown in FIG. 2B, voxels positioned on a corner of the rectangular box 50 indicated as a voxel V (1,1,1), a voxel V (1,7,1), a voxel V (7,1,1), and a voxel V (7,7,1) (not shown), when the voxel layer is a first layer, for example. In addition, when the voxel layer is a sixth layer, the voxels are indicated as a voxel V (1,1,6), a voxel V (1,7,6), a voxel V (7,1,6), and a voxel V (7,7,6).

In a case of forming such a rectangular box 50 configured with a plurality of voxels, the control unit 15 generates the rectangular box 50 on the formation table 30 by outputting each driving signal generated based on the voxel data of each voxel V (x,y,z) at a predetermined timing.

That is, the control unit 15 moves the carriage 23 (discharging head 20) in the upper portion of the formation table 30 in the +Y direction along the main scanning direction Y, as shown with a white arrow in FIG. 2A. The nozzle driving signals DNC, DNM, DNY, DNK, DNW, and DNT are output at a predetermined timing during the movement of the carriage 23 and the liquids according to the discharging data corresponding to voxels V (x,y,1) of the first layer, for example, is discharged from each nozzle N of the discharging unit 20 to the formation table 30. After completing the discharging of the liquids from the discharging unit 20, the control unit 15 outputs the curing unit driving signal DKL to perform light irradiation by the curing unit 40, and cures the discharged liquids by the emitted light to form each voxel V (x,y,1) of the first layer.

When subsequently forming a voxel layer (for example, a second voxel layer), the control unit 15 operates the lifting unit 31 to lift down the formation table 30 by a height of one voxel. Then, the control unit 15 repeatedly executes the same procedures to form each voxel v (x,y,z) of six voxel layers configuring the rectangular box 50, and forms the rectangular box 50 which is a three-dimensional object on the formation table 30.

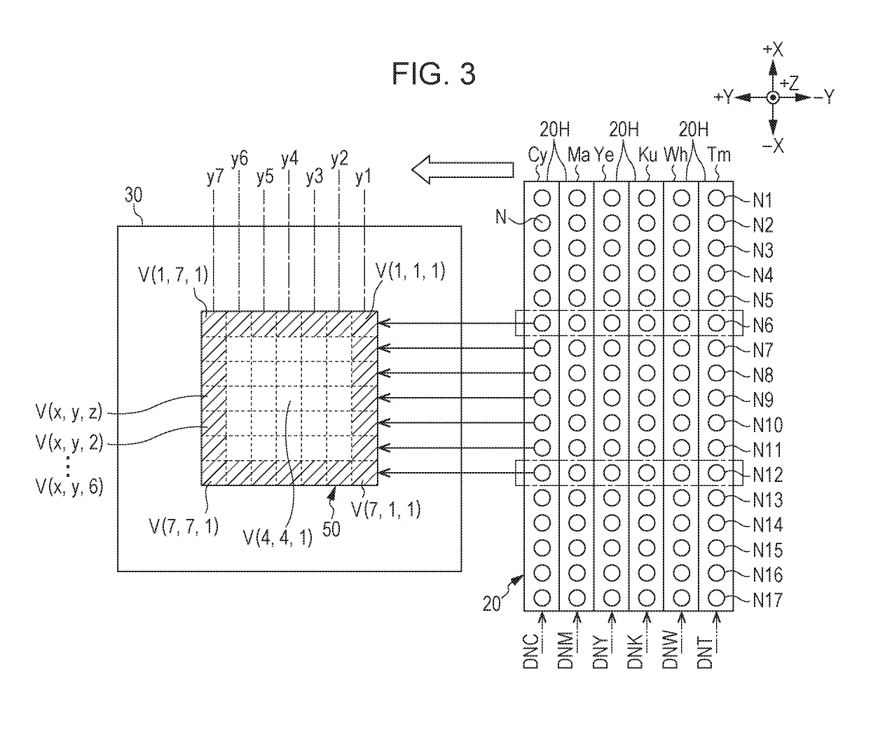

In the embodiment, as shown in FIG. 3, a nozzle array of 17 nozzles N of a nozzle N1 to a nozzle N17 are provided to be arranged to be one column in the auxiliary scanning direction X in each of the six individual heads 20H configuring the discharging unit 20. A width of one voxel in the auxiliary scanning direction X and a pitch between the nozzles N are set to have the same dimension (same length) so that one nozzle N of each individual head 20H corresponds to one voxel V (x,y,z) in the auxiliary scanning direction X.

In the embodiment, the nozzles N provided in each individual head 20H of the discharging unit 20 as described above are arranged as one line along the main scanning direction Y. As shown with two lines thereof surrounded by an alternate long and short dash line as an example in FIG. 3, six nozzles N which one set arranged in the main scanning direction Y configured with the nozzles N of each individual head 20H function as discharging sections which discharge liquids with respect to one voxel V (x,y,z).

In the embodiment, each voxel V (x,y,1) of the first voxel layer of the rectangular box 50 form a bottom portion of the rectangular box 50 and is formed by liquids discharged from total seven (seven sets of) discharging sections including discharging sections configured with six nozzles N6 which is one set to discharging sections configured with six nozzles N12 which is one set, among the nozzles N included in each of the six individual heads 20H.

For example, when the nozzles N6 of each individual head 20H have arrived a position y1 to a position y7 in the main scanning direction Y according to the movement of the carriage 23, the liquid having each color is discharged from the nozzles N6 to seven voxel V (1,1,1) to voxel V (1,7,1) of a first row which are positioned as first voxels in the auxiliary scanning direction X and arranged in the main scanning direction Y. In the same manner as described above, when the nozzles N12 of each individual head 20H have arrived the position y1 to the position y7 in the main scanning direction Y according to the movement of the carriage 23, the liquid having each color is discharged from the nozzles N12 to seven voxel V (7,1,1) to voxel V (7,7,1) of a seventh row which are positioned as seventh voxels in the auxiliary scanning direction X and arranged in the main scanning direction Y.

As shown using a hatched area in FIG. 3, each voxel V (x,y,2) of the second voxel layer to each voxel V (x,y,6) of the six voxel layer of the rectangular box 50 are voxels for forming standing wall portions of the rectangular box 50 and are overlapped with the voxels positioned on the lower layer side. Accordingly, in the same manner as in the first voxel layer, each voxel V (x,y,2) of the second voxel layer to each voxel V (x,y,6) of the six voxel layer are formed by liquid having each color discharged from total seven discharging sections including discharging sections configured with six nozzles N6 to discharging sections configured with six nozzles N12 in each individual heads 20H.

Next, an operation of the printer 11 of the embodiment will be described.

In the embodiment, as the operation, a formation operation process for a three-dimensional object of forming each voxel is performed by controlling the display color and the transparency thereof, when forming each voxel configuring the rectangular box 50. The formation operation process for a three-dimensional object is performed by the control unit 15 and is started by executing a three-dimensional object formation program recorded in the recording medium 13 inserted into the insertion port 12a of the housing 12 with a command signal from the operation unit 14. The formation operation process will be described with reference to the drawings.

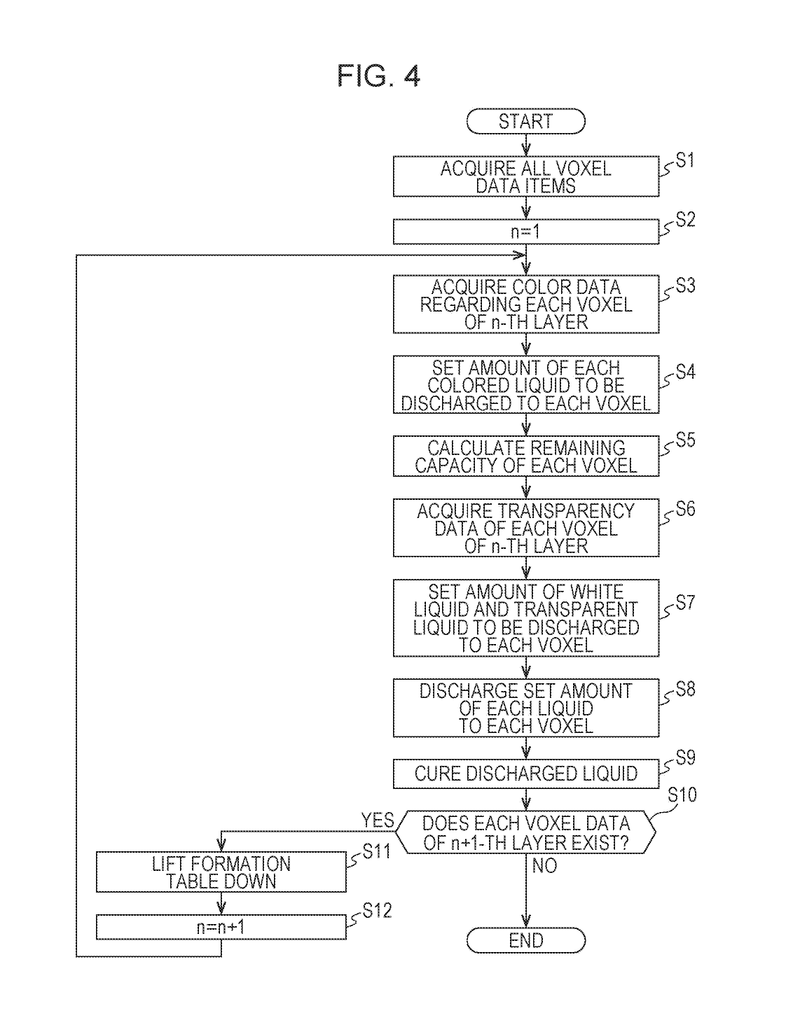

As shown in FIG. 4, when the formation operation process is started, first, in Step S1, a process of acquiring all voxel data items generated regarding a three-dimensional object which is a formation target is performed. By performing this process, the position data, the color data, and the transparency data respectively showing positions, display colors, and transparency of all voxels configuring the rectangular box 50 in a three-dimensional space on the formation table are acquired.

In Step S2, a process of “n=1” of setting a value of “n” indicating the number of times of process as “1” is performed. This process is performed when the control unit 15 records a value “1” indicating an initial process in a recording unit (not shown) included in the housing 12 as a value of “n”.

In Step S3, a process of acquiring the color data of each voxel of n-th layer is performed. Herein, the process is performed when the control unit 15 first extracts the color data of each voxel configuring the first voxel layer from the acquired entire voxel data items.

In Step S4, a process of setting amounts of each colored liquid to be discharged to each voxel is performed and, subsequently, a process of calculating remaining capacity of each voxel is performed in Step S5. Herein, the control unit 15 performs a necessary process such as a color conversion process or a half-tone process from the color data items indicating R, G, and B of each voxel of the first layer and generates the discharging data configured with data values indicating amounts (discharging amounts) of four colored liquid Cy, Ma, Ye, and Ku discharged from the nozzles N to each voxel. The amounts of each colored liquid to be discharged are set using the discharging data generated as described above. The control unit 15 calculates the remaining capacity of each voxel using the set amounts of the liquids.

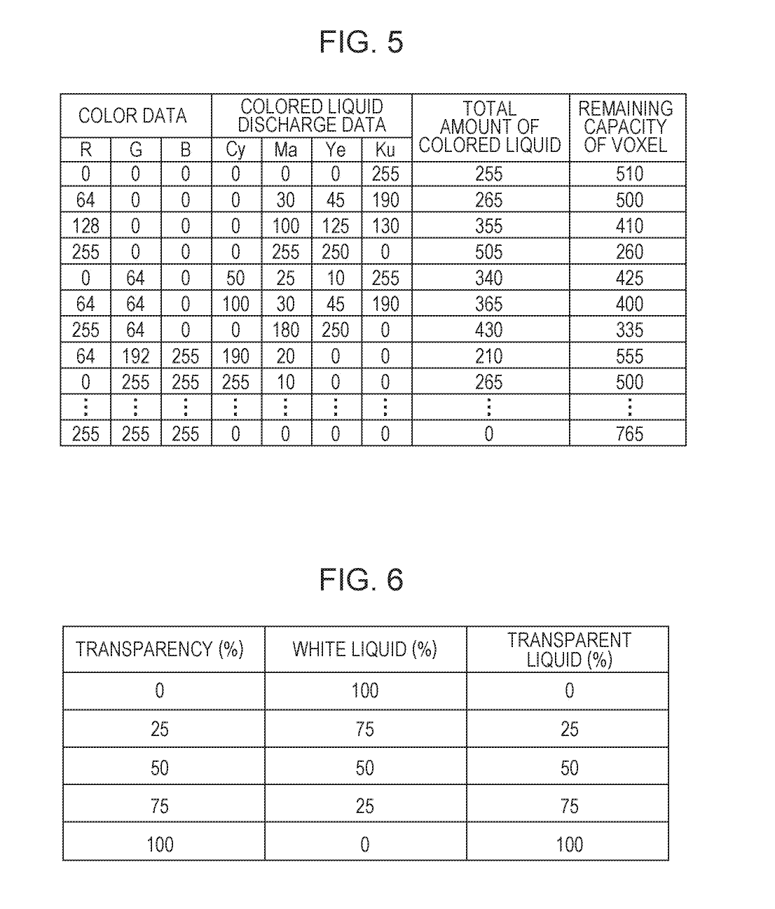

An example of the processes in Step S4 and Step S5 will be described with reference to FIG. 5.

In the embodiment, as shown in a table of FIG. 5, as an example, in the process in Step S4, the color data items of R (red), G (green), and B (blue) having the maximum value represented as “255” are converted into the discharging data items of each colored liquid Cy, Ma, Ye, and Ku having the maximum value represented as “255” in the same manner, and the discharging data items are generated. For example, a discharging data item in which only the colored liquid Ku (black) is set to have the maximum value of “255” is generated for a voxel of the color data indicating black in which all values of R, G, and B are “0”. In addition, a discharging data item in which a value of a discharging amount of the colored liquid Ma (magenta) is “255” and a value of a discharging amount of the colored liquid Ye (yellow) is “250” is generated for a voxel of the color data indicating red having a high chroma in which a value of R is the maximum value “255” and each value of G and B is “0”. Further, discharging data items in which all values regarding the colored liquids Cy, Ma, Ye, and Ku are “0” are generated for a voxel of the color data indicating white in which all values of R, G, and B are the maximum value “255”.

In the embodiment, a discharging amount of the liquid for filling the volume of one voxel is obtained in a case of a discharging data item in which all values regarding the chromatic colored liquids Cy, Ma, and Ye are the maximum value “255”, that is, when the discharging data has a value of “765”. That is, the total capacity indicating the volume of one voxel is set as the maximum discharging amounts of the colored liquids Cy, Ma, and Ye which can be set the inner portion of the voxel indicated as black with the color data, as black, without using the black liquid Ku. With respect to this, in the embodiment, only the black liquid Ku is discharged to a voxel indicated as black by the maximum discharging amount thereof. As described above, even when the amount of liquid is maximum, the discharging amount of each colored liquid discharged according to the discharging data generated by the process in Step S4 fills only a part of the total capacity of the voxel, so that total capacity in the voxel is not entirely filled and a remaining portion is formed.

In the subsequent process in Step S5, the remaining portion other than the portion filled with the colored liquids Cy, Ma, Ye, and Ku among the total capacity of the voxel is calculated as a value indicating remaining capacity, as shown in a vertical column of the right end of the table of FIG. 5. That is, a difference between the value “765” indicating the total capacity of one voxel and a value of the total amount of the colored liquid indicating a total value of each discharging amount of the colored liquids Cy, Ma, Ye, and Ku is calculated as a value indicating remaining capacity.

In the embodiment, the discharging data items of each of the colored liquids Cy, Ma, Ye, and Ku is set as a value of integral time of the value “5”. That is, the value “5” indicated by the discharging data corresponds to the amount of liquid (minimum liquid amount) discharged from each nozzle N of the discharging unit 20 by one discharging operation. That is, one voxel is filled by a 153 times of discharging operations of the liquid which is obtained by dividing the value “765” indicating the total capacity of one voxel by the value “5”.

Returning to FIG. 4, in Step S6, a process of acquiring the transparency data of each voxel of n-th layer is performed. Herein, the process is performed when the control unit 15 extracts the transparency data of each voxel of the first voxel layer from the acquired entire voxel data items.

In Step S7, a process of setting the amount of the white liquid and the transparent liquid to be discharged to each voxel is performed. Herein, the amounts of each of the white liquid Wh which is a white liquid for filling the remaining capacity of the voxel and the transparent liquid Tm are set from the transparency data of each voxel of the first voxel layer and values indicating the remaining capacity of each voxel calculated in Step S5.

The processes in Step S6 and Step S7 will be described with reference to FIG. 6.

In the embodiment, as five transparency levels of transparency of 0% (opaque) to transparency of 100% (transparent) are shown as an example in a table of FIG. 6, the amounts of the white liquid Wh and the colorless transparent liquid Tm to be discharged are set at a ratio according to the transparency. For example, when the transparency is 0%, the amounts of each liquid are set so that the remaining capacity of the voxel is filled by the nozzles N of each individual head 20H at a ratio of 100% of the white liquid Wh and 0% of the transparent liquid Tm, and on the other hand, when the transparency is 100%, the amounts of each liquid are set at a ratio of 0% of the white liquid Wh and 100% of the transparent liquid Tm. When the transparency is 50%, the amounts of each liquid are set so that the remaining capacity of the voxel is filled by the nozzles N of each individual head 20H at a ratio of 50% of the white liquid Wh and the transparent liquid Tm. As described above, in the embodiment, the transparency is set as a ratio of the amounts of the colorless transparent liquid with respect to the white liquid which is the achromatic colored liquid.

Returning to FIG. 4, in Step S8, a process of discharging the set amounts of each liquid to each voxel is performed. This process will be described with reference to the drawings. Herein, among the voxels V (4,y,z) of the rectangular box 50 which are formed by discharging each liquid from the nozzles N9 of the discharging unit 20, a voxel V (4,4,1) configuring the first voxel layer which is the fourth voxel in the main scanning direction Y (see FIG. 3) will be described as an example.

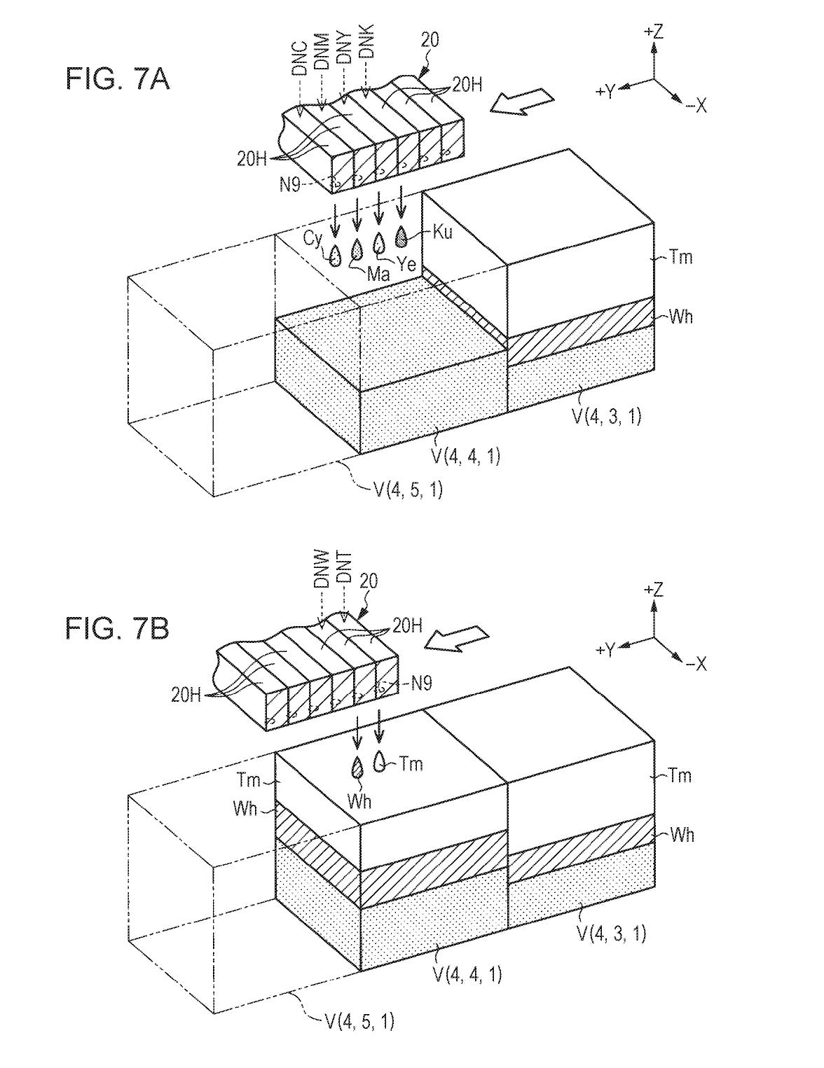

As shown in FIGS. 7A and 7B, each liquid is discharged from each nozzle N9, when each nozzle N9 provided in the individual heads 20H of the discharging unit 20 which moves in the +Y direction along the main scanning direction Y is moved to a formation position (herein, center position of voxels) of the voxel V (4,4,1) which is the fourth voxel in the main scanning direction Y. That is, in the embodiment, each liquid is discharged to the voxel V (4,4,1) which is a formation target from the discharging unit 20 which moves in a direction indicated by a white arrow in the drawings and is shown as a partially cut state, in the order of the colored liquids Cy, Ma, Ye, Ku, and Wh and the transparent liquid Tm.

Specifically, as shown in FIG. 7A, the nozzle driving signals DNC, DNM, DNY, and DNK are output at the timing when the nozzles N9 of the four individual heads 20H positioned on the +Y side of the discharging unit 20 in the main scanning direction Y are moved to the formation position of the voxel V (4,4,1) in order. As a result, the set amounts of the colored liquids Cy, Ma, Ye, and Ku are discharged from the nozzles N9 to the voxel (4,4,1). A part of the total capacity indicating the volume of the voxel V (4,4,1) is filled with the amounts of the discharged colored liquids Cy, Ma, Ye, and Ku, as shown with a half-tone dotted area of FIG. 7A, and a display portion according to the color data of the voxel is formed. In addition, in the embodiment, a value of the discharging data indicating the total amounts of the colored liquids of the voxel V (4,4,1) is set as “365” and a value of the discharging data indicating the remaining capacity of the voxel is set as “400”.

Next, as shown in FIG. 7B, the nozzle driving signals DNW and DNT are output at the timing when the nozzles N9 of the two individual heads 20H positioned on a side opposite to the +Y side of the discharging unit 20 in the main scanning direction Y are moved to the formation position of the voxel V (4,4,1) in order. As a result, the set amounts of the white liquid Wh and the transparent liquid Tm are discharged from the nozzles N9. The remaining capacity which is a remaining part other than a part of the total capacity of the voxel V (4,4,1) is filled with the amounts of the discharged colored liquid Wh and the transparent liquid Tm, as shown with a hatched area and an unpatterned area of FIG. 7B, and a transparent portion according to the transparency data of the voxel is formed. In addition, in the embodiment, the transparency data indicates the transparency of 50%, the colored liquid Wh and the transparent liquid Tm are discharged to the voxel V (4,4,1) with the amounts of the liquids corresponding to the half value “200” of value “400” of the discharging data indicating the remaining capacity, and the voxel V (4,4,1) is entirely filled with the liquids.

As shown in FIGS. 7A and 7B, regarding a voxel V (4,3,1) of which the total capacity is filled with each liquid discharged from the discharging unit 20, approximately one-third part of the total capacity is filled with colored liquids as shown with a half-tone dotted area of the drawing, before the voxel V (4,4,1). 25% of the remaining capacity which is a remaining portion is filled with the white liquid Wh as shown with the hatched area of the drawing and 75% thereof is filled with the transparent liquid Tm as shown with the unpatterned area of the drawing. That is, in the transparency data of the voxel V (4,3,1), the transparency is set as 75%. By doing so, each voxel V (x,y,1) of the first layer of the rectangular box 50 which is a three-dimensional object is filled with each discharged liquid.

Returning to FIG. 4, in Step S9, a process of curing each discharged liquid is performed. After completing the discharging of the liquids from the discharging unit 20, the control unit 15 outputs the curing unit driving signal DKL to perform light irradiation by the curing unit 40, and cures each liquid discharged to each voxel V (x,y,1) by the emitted light to form each voxel V (x,y,1) of the first layer. That is, the liquid discharged to the position of the voxel V (x,y,1) is cured in the position by irradiation performed by the curing unit 40, to form one voxel layer configuring the rectangular box 50.

In the embodiment, the control unit 15 outputs the first motor driving signal DM1 to move the carriage 23 to the original position, before starting the formation of the next voxel layer. When forming the next voxel layer without moving the carriage 23 to the original position, the carriage 23 may be moved in a direction opposite to a case of the voxel layer formed immediately. In this case, the discharging order of the color of the liquids discharged to the voxels is reversed.

In Step S10, a process of determining whether or not there is the discharging data of an (n+1)-th layer is performed. This determination process is performed when the control unit 15 determines whether or not the voxel data of the voxel configuring the (n+1)-th (herein, second) voxel layer is acquired, in the process in Step S1. As a result of the determination, when the discharging data is not acquired (Step S4: NO), the formation of the rectangular box 50 which is a three-dimensional object is completed, and accordingly, the formation operation process herein is completed.

Meanwhile, when the discharging data is acquired (Step S10: YES), the formation of the rectangular box 50 is not completed, and accordingly, a process of lifting the formation table down is performed in the next Step S11. That is, in order to form the voxel of the (n+1)-th (second) voxel layer to be formed on the n-th (first) layer, the control unit 15 outputs the second motor driving signal DM2 to lift down the formation table 30 in the gravity direction by a dimension of one voxel layer.

In Step S12, a process of “n=n+1” of adding 1 to the value of “n” indicating the number of times of process is performed. After that, returning to the process in Step S3 again, the same subsequent processes are repeated. In the determination process in Step S10 again, when the discharging data of the (n+1)-th layer is generated (Step S10: YES), the formation of the rectangular box 50 is not completed, and accordingly, the processes from Step S3 to Step S10 are repeatedly performed and the voxel of each voxel layer (from first layer to sixth layer) is formed.

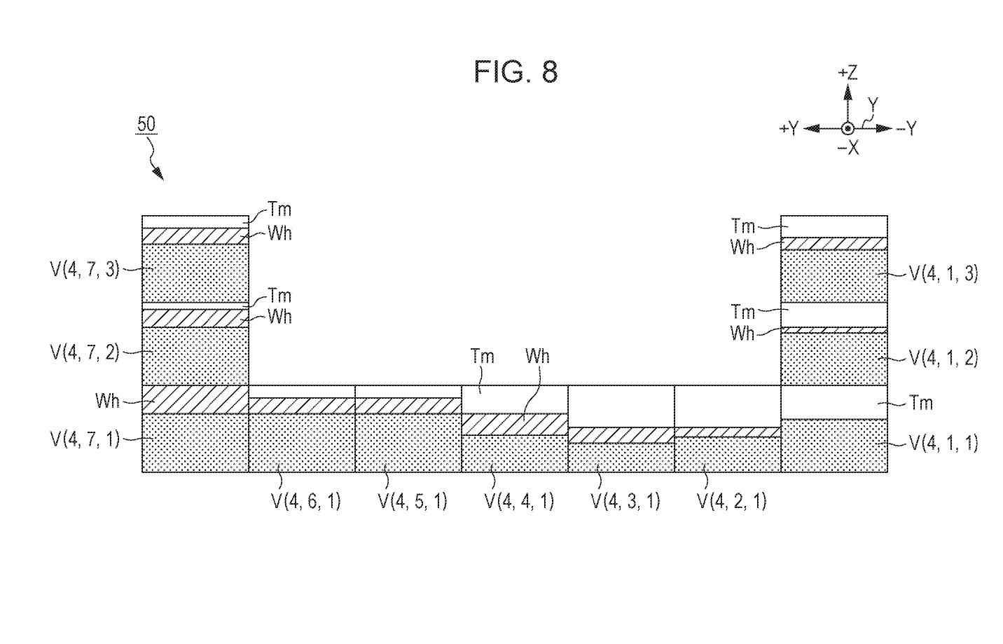

FIG. 8 shows, as an example, voxels of first to third voxel layers which are formed by repeatedly performing the processes from Step S3 to Step S10 three times during the formation operation process of the rectangular box 50, among the voxels V (4,y,z) of a fourth row which are positioned as fourth voxels in the auxiliary scanning direction X and arranged in the main scanning direction Y.

In the embodiment, as shown in FIG. 8, the first voxel V (4,1,1) in the main scanning direction Y among voxels of the first voxel layer formed by the formation operation process is formed with transparency of 100% in which the remaining capacity of the voxel is filled only with the transparent liquid Tm. Meanwhile, the seventh voxel (4,7,1) in the main scanning direction Y is formed with transparency of 0% in which the remaining capacity of the voxel is filled only with the white liquid Wh. The five voxels between the two voxels are formed so that a ratio of the amounts of the colored liquid Wh with respect to the transparent liquid Tm is set to be increased from the voxel V (4,1,1) to the voxel V (4,4,1) and the transparency is gradually decreased from 100% to approximately 50%, and the voxel V (4,4,1) to the voxel V (4,6,1) are formed with the transparency of 50%.

In first voxels in the main scanning direction Y among the voxels of the first to third voxel layers, a ratio of the amounts of the colored liquid Wh with respect to the transparent liquid Tm is increased from the first voxel V (4,1,1) to the third voxel V (4,1,3). Accordingly, the voxels are formed so that the transparency is gradually decreased from 100% to approximately 60%. Meanwhile, in the seventh voxels in the main scanning direction Y, a ratio of the amounts of the transparent liquid Tm with respect to the colored liquid Wh is increased from the first voxel V (4,7,1) to the third voxel V (4,7,3), and accordingly, the voxels are formed so that the transparency is gradually increased from 0% to approximately 40%.

FIGS. 7A, 7B, and 8 show a state in which each liquid is laminated in the vertical direction Z without mixing the liquids in the voxels, but the liquids are not limited to be in a laminated state, and the liquids may be mixed with each other.

According to the embodiment, the following effects can be obtained.

(1) The transparency of the voxels to be formed is controlled with a ratio of the amounts between the white achromatic liquid Wh and the colorless transparent liquid Tm to be discharged. Accordingly, regarding the three-dimensional object (rectangular box 50) to be formed with the plurality of voxels, it is possible to control the set transparency while preventing a hue change, without darkening the display color (decreasing brightness).

(2) A state where the total capacity (all portions) of the voxels is filled with the colored liquids Cy, Ma, Ye, and Ku discharged for generating the display color of the three-dimensional object (rectangular box 50) is prevented, and a remaining portion to which the achromatic liquid Wh and the colorless transparent liquid Tm can be discharged is formed in the voxel. Accordingly, regarding the three-dimensional object (rectangular box 50) to be formed with the plurality of voxels, it is possible to control the transparency thereof by the achromatic liquid Wh and the transparent liquid Tm.

The embodiment may be changed to another embodiment described below.

In the embodiment, the discharging unit 20 may not discharge the white liquid Wh and the colorless transparent liquid Tm contained in the liquids, by an amount of the liquids at a ratio according to the transparency data generated from the set transparency. For example, the remaining capacity of the voxel may be filled with the black liquid Ku among achromatic liquids and colorless transparent liquid Tm and the black liquid Ku and colorless transparent liquid Tm may be discharged by an amount of the liquids at a ratio according to the set transparency. Alternatively, the remaining capacity of the voxel may be filled with a gray liquid among achromatic liquids, that is, a liquid obtained by mixing the white liquid Wh and the black liquid Ku with each other at a predetermined ratio, and the colorless transparent liquid Tm, and the gray liquid and the colorless transparent liquid Tm may be discharged by an amount of the liquids at a ratio according to the set transparency.

According to the examples, the following effects are exhibited, instead of the effect (1) of the embodiment.

(3) The voxels configuring the three-dimensional object (rectangular box 50) is set to have display colors set with the discharged liquids Cy, Ma, Ye, and Ku, and the transparency of the voxels to be formed are controlled by a ratio of the amounts of the achromatic black or gray liquid and colorless transparent liquid Tm to be discharged. Accordingly, regarding the three-dimensional object (rectangular box 50) to be formed with the plurality of voxels, brightness of the display color of the voxels changes, but it is possible to control the set transparency while preventing a hue change.

In the embodiment, the brightness is set as the display color of each voxel, in addition to the color hue and the chroma. In order to generate the set display color of the voxels, the white liquid Wh may also be discharged to the voxels, in addition to the colored liquids Cy, Ma, Ye, and Ku. In this case, among liquids to be discharged for generating the display color of the voxel, the transparent liquid Tm may be discharged by an amount of the liquids at a ratio according to the set transparency with respect to the amount of the white liquid Wh. Alternatively, the transparent liquid Tm may be discharged by an amount of the liquids at a ratio according to the set transparency with respect to the total amount of white liquid Wh and the black liquid Ku to be discharged for generating brightness and chroma, in addition to the hue among the display color of the voxel.

In this case, each discharging amount is set so that all voxels are filled with the colored liquids Cy, Ma, Ye, Ku, Wh containing white and black liquid and the transparent liquid Tm to be discharged. That is, regarding each voxel, the colorless transparent liquid Tm is discharged so as to obtain the set transparency while filling the remaining capacity of the voxels. That is, regarding each voxel configuring the three-dimensional object, it is possible to prevent a change of the display colors (hue, chroma, and brightness) of the voxels and to control the transparency of the voxels according to the set transparency, for example.

In the embodiment, the capacity of one voxel may not be set as the maximum discharging amount of the colored liquids Cy, Ma, and Ye which can be set the voxels of which the color data indicates black, as black by mixing without using the black liquid Ku. For example, as long as a value exceeds the maximum value of the total value of the discharging amount of each colored liquid converted from the color data items of the R, G, and B, the capacity of one voxel may be set to any value.

Alternatively, in the embodiment, the total capacity of one voxel may be a value equivalent to the maximum value of the total value of the discharging amount of each colored liquid converted from the color data items of R, G, and B. The voxel of which the total capacity is set as a total value of the maximum discharging amount of each colored liquid, is set as a voxel having transparency of 0%.

In the embodiment, the colored liquid Cy may not be initially discharged and each liquid may not be discharged in order of the colored liquid Ma, Ye, Ku, and Wh and the transparent liquid Tm, with respect to one voxel V (x,y,z) which is a formation target. For example, the colored liquid Ye may be initially discharged or the transparent liquid Tm may not be initially discharged. Each liquid is added when the discharging unit 20 moves (forwards) in the +Y direction of the main scanning direction Y and the liquid may be discharged from the discharging unit 20 even when the discharging unit reversely moves (backwards) in the −Y direction. When discharging each liquid in the reciprocating of the discharging unit 20, each liquid may be discharged to the voxel in a reverse order of the moving forward and moving backward.

In the embodiment, the individual head 20H configuring the discharging unit 20 is not limited to line heads set as one head which extends in the auxiliary scanning direction X and may be a head having other configurations. For example, although not shown herein, the individual head 20H may be a line head configured with divided heads which are divided into a plurality of pieces in the auxiliary scanning direction X.

In the embodiment, the discharging section for discharging liquid to the voxel may not be configured with one nozzle N of each individual head 20H with respect to one voxel. For example, the discharging section may have a configuration of discharging the liquid from one or more nozzles which are three or four nozzles, with respect to one voxel. In this case, the nozzle array is not limited to one array, either, and a plurality of arrays may be provided. That is, the discharging section may be configured with one or more nozzles necessary for discharging the liquid for filling the total capacity (volume) of one voxel.

In the embodiment, the number of individual heads 20H may not be six. For example, the number of individual heads may be five or smaller or seven or greater. In addition, the colors of the liquid are not limited to chromatic colors of cyan, magenta, and yellow and achromatic colors of black and white. The printer 11 which is the three-dimensional object formation apparatus may have the number of colors necessary for forming the three-dimensional object and the number of individual heads 20H according to the number of colors.

In the embodiment, the printer 11 which is the dimensional object formation apparatus may be an apparatus which forms a three-dimensional object by discharging a fluid other than the thermosetting liquid (containing liquid, liquid-like object obtained by dispersing or mixing particles of a function material with liquid, a fluid-state object such as gel, or solid body which can be discharged by flowing the solid body as a fluid). For example, the fluid may be a thermosetting resin which is cured by heating, a thermosoftening resin which is softened by heating, in the other hand, or metal.

What is claimed is:

1. A three-dimensional object formation apparatus comprising:
a discharging unit which discharges a plurality of achromatic colored liquids and a colorless transparent liquid; and
a curing unit which cures a liquid discharged from the discharging unit to a formation table to form a voxel configuring a three-dimensional object on the formation table,
wherein a display color and transparency of the voxel are set,
the discharging unit discharges the colored liquid by an amount of liquid according to the display color, and discharges the achromatic colored liquids and the colorless transparent liquid by an amount of the liquids at a ratio according to the transparency, so that a remaining portion which is other than a portion filled with the discharged colored liquid among total capacity of the voxel is filled, and
the curing unit cures the discharged colored liquid and the transparent liquid to form the voxels.

2. The three-dimensional object formation apparatus according to claim 1,
wherein the discharging unit discharges the white liquid among the achromatic colored liquids and the colorless transparent liquid by an amount of the liquids at a ratio according to the set transparency.

3. The three-dimensional object formation apparatus according to claim 1,
wherein the discharging unit discharges the colored liquids so that the remaining portion is formed in the voxel.

4. A three-dimensional object formation method which is executed by a three-dimensional object formation apparatus including a discharging unit which discharges a plurality of achromatic colored liquids and a colorless transparent liquid, and a curing unit which cures a liquid discharged from the discharging unit to a formation table to form a voxel configuring a three-dimensional object on the formation table in which a display color and transparency of the voxel are set, the method comprising:
causing the discharging unit to discharge the colored liquid by an amount of liquid according to the display color, and discharge the achromatic colored liquids and the colorless transparent liquid by an amount of the liquids at a ratio according to the transparency, so that a remaining portion which is other than a portion filled with the discharged colored liquid among total capacity of the voxel is filled; and
causing the curing unit to cure the discharged colored liquid and the transparent liquid to form the voxels.

5. A three-dimensional object formation program executed by a control unit of a three-dimensional object formation apparatus including a discharging unit which discharges a plurality of achromatic colored liquids and a colorless transparent liquid, a curing unit which cures a liquid discharged from the discharging unit to a formation table to form a voxel configuring a three-dimensional object on the formation table, and the control unit which controls the discharging unit and the curing unit,
wherein a display color and transparency of the voxel are set, and
the three-dimensional object formation program causes the control unit to execute:
causing the discharging unit to discharge the colored liquid by an amount of liquid according to the display color, and discharge the achromatic colored liquids and the colorless transparent liquid by an amount of the liquids at a ratio according to the transparency, so that a remaining portion which is other than a portion filled with the discharged colored liquid among total capacity of the voxel is filled; and
causing the curing unit to cure the discharged colored liquid and the transparent liquid to form the voxels.
